(19) United States
(12) Patent Application Publication
(10) Pub. No.: US 2026/0255106 A1
(43) Pub. Date: Aug. 27, 2026

(54) OBLONG MINIATURE RECEIVER FOR HEARING DEVICES

(71) Applicant: Sonion Nederland B.V., Hoofddorp (NL)

(72) Inventor: Raymond MÖGELIN, Hoofddorp (NL)

(73) Assignee: Sonion Nederland B.V., Hoofddorp (NL)

(21) Appl. No.: 18/874,954

(22) PCT Filed: Jul. 14, 2023
(86) PCT No.: PCT/EP2023/069616

§ 371 Date: Dec. 13, 2024

(30) Foreign Application Priority Data
Jul. 21, 2022 (EP) 22186236.0

(51) Int. Cl. H04R 9/02; H04R 7/18; H04R 9/06; H04R 25/00

(52) U.S. Cl. CPC H04R 9/025; H04R 7/18; H04R 9/06; H04R 25/48; H04R 25/604; H04R 2307/027; H04R 2400/11

(57) ABSTRACT

The present invention relates to a miniature receiver for a hearing device, said miniature receiver comprising an oblong housing, a sound output port arranged in the oblong housing, a hinged diaphragm arranged within the oblong housing and separating a front volume and a rear volume within the oblong housing, wherein the hinged diaphragm comprises a hinged portion and a moveable portion, and wherein at least the moveable portion of the hinged diaphragm is adapted to vibrate in response to a drive signal applied to a voice coil secured to the moveable portion of the diaphragm, and a magnetic motor arranged within the oblong housing, wherein the magnetic motor is adapted to generate a static magnetic field in an air gap within which at least part of voice coil is positioned. The present invention also relates to an audio assembly for a hearing device comprising a nozzle having a sound channel within which sound channel a miniature receiver is at least partly positioned. The present invention further relates to a hearing device comprising a miniature receiver, or an audio assembly.

### FIELD OF THE INVENTION

The present invention relates to an oblong miniature receiver for hearing devices. The oblong miniature receiver comprises a hinged diaphragm comprising a hinged portion and a moveable portion, wherein at least the moveable portion of the hinged diaphragm is adapted to vibrate, and thus generate sound waves, in response to a drive signal applied to a voice coil secured to the moveable portion of the diaphragm.

### BACKGROUND OF THE INVENTION

Within the hearing aid industry, the shape and dimensions of the hearing aid components forming the hearing aid devices are of great importance as these components need to fit into the hearing devices, such as hearing devices being at least partly positioned in the ear canal of the user of the hearing device. An example of such a hearing device is the In-The-Ear (ITE) hearing aid.

With respect to ITEs the shape and dimensions of the receiver are of particular importance in that the receiver needs to fit into the nozzle of the hearing device. In the hearing aid industry, the term “receiver” is commonly used to refer to a sound generating device, i.e. a speaker.

Moreover, in conventional designs of miniature receivers the small diaphragm sizes are, in general, associated with relatively large driving amplitudes, which in combination frequently triggers problems with rocking modes. Since the amplitude of the tilting motion scales with voice coil excursion, and since the air gaps for the voice coil are narrow for efficiency reasons, the voice coil will at a certain level hit the magnet causing excessive impulsive distortion due to rubbing. The rubbing of the voice coil along the air gap (magnet) wall also quickly breaks the coatings of the voice coil wire and can thus cause the receiver to fail. Thus, the risk of cocking modes imposes strong limitations of usable output and lifetime of conventional miniature receivers.

Examples of prior art references are US 2021/360350 A1 and US 2021/051410 A1. However, with respect to US 2021/360350 A1 at least the planar coil seems to be arranged in a different manner compared to the present invention, and with respect to US 2021/051410 A1 the coil windings seem to be secured to the hinged portion, and not the moveable portion, of the diaphragm.

It may be seen as an object of embodiments of the present invention to provide a miniature receiver having an outer shape that fits into the nozzle of hearing devices without compromising the acoustical performance of the receiver.

It may be seen as a further object of embodiments of the present invention to provide a miniature receiver where the risk of rocking modes is significantly reduced.

### DESCRIPTION OF THE INVENTION

The above-mentioned objects are complied with by providing, in a first aspect, a miniature receiver for a hearing device, said miniature receiver comprising
1) an oblong housing,
2) a sound output port arranged in the oblong housing,
3) a hinged diaphragm arranged within the oblong housing and separating a front volume and a rear volume within the oblong housing, wherein the hinged diaphragm comprises a hinged portion and a moveable portion, and wherein at least the moveable portion of the hinged diaphragm is adapted to vibrate in response to a drive signal applied to a voice coil secured to the moveable portion of the diaphragm, and
4) a magnetic motor arranged within the oblong housing, wherein the magnetic motor is adapted to generate a static magnetic field in an air gap within which at least part of voice coil is positioned.

Thus, the present invention relates to a miniature receiver for generating audible sound waves. The miniature receiver is adapted to be used in hearing devices, and for that reason the miniature receiver is very small. Typical dimensions (length×width×height) are 6-9 mm length, 3-4 mm in width, and around 1.5-2.5 mm in height.

The miniature receiver of the present invention is a so-called moving coil receiver where the voice coil is secured to the moveable portion of the hinged diaphragm. Since the voice coil is least partly ranged in the air gap with the static magnetic field at least the moveable portion of the hinged diaphragm will vibrate, and thus generate sound waves in the audible range, in response to the drive signal applied to the voice coil.

the present context the term “hinged diaphragm” should be understood as a diaphragm that is hinged to for example a frame structure. The hinging of the diaphragm to for example a frame structure may be arranged in various ways, such as by applying one or more integrated hinges, applying one or more distinct and separate hinges and/or one or more film-based hinges.

Hinging of the diaphragm is advantageous in that the hinge avoids or at least counteracts rocking modes, i.e. undesired tilting motions of the diaphragm which is a widely known phenomena in conventional (non-hinged) moving coil loudspeaker designs.

Moreover, the use of a hinged diaphragm in combination with a moving coil driver is advantageous, in particular, if the diaphragm area is small, and consequently the deflection amplitude of the diaphragm is large. In such cases the presence of hinges prevents the occurrence of rocking modes at high frequencies. Additionally, the presence of hinges provides guidance for the voice coil in the narrow air gap, and thus prevents mechanical rubbing. In the miniature receiver of the present invention the hinged diaphragm may be hinged to a frame structure, and one or more openings may exist between the hinged diaphragm and the frame structure. The one or more openings may exist between one or more hinges that suspend the hinged diaphragm. The hinged portion of the hinged diaphragm may be hinged to a frame structure via one or more discrete and separate hinges, such as glue pads. Alternatively, or in combination therewith, the hinged portion of the hinged diaphragm may be hinged to a frame structure via one or more integrated hinges.

In the present context the term “integrated hinges” is to be understood as hinges that are integrated with the frame structure, the hinged diaphragm or both. The hinged diaphragm and the frame structure may form an integrated structure of the same material, such as metal including aluminium.

The one or more openings between the hinged diaphragm and the frame structure are provided so that at least part of the hinged diaphragm is allowed to vibrate, and thus generate audible sound waves, when a drive signal is applied to the voice coil. The one or more openings between the hinged diaphragm and the frame structure may at least partly be sealed or filled with a flexible sealing member, such as a (corrugated) polymer film or a viscoelastic substance, such as a viscoelastic gel. Sealing the one or more openings is advantageous in order to acoustically separate the front and rear volumes of the miniature receiver.

At least part of the hinged diaphragm may comprise an embossed part for increasing the stiffness of the diaphragm. The embossed part may be implemented as an indentation or recess that extend in the opposite direction of the voice coil secured to the moveable portion of the diaphragm. Another way of increasing the stiffness of the hinged diaphragm may be to secure a stacked layer or stacked pre-formed layer to the diaphragm.

The embossed part of at least part of the hinged diaphragm may provide an air venting path for air inside the magnetic motor as discussed in relation to some of the drawings.

Preferably, the hinged diaphragm has an oblong shape, wherein the length of the hinged diaphragm in the oblong direction is at least twice the width of the diaphragm. Thus, the length of the hinged diaphragm in the oblong direction may be three times, four times, five times or even ten times the width of the diaphragm. The oblong shape of the hinged diaphragm is advantageous in that it maximises the area of the hinged diaphragm within the oblong housing of the miniature receiver. Moreover, the maximised area of the hinged diaphragm enhances the performance of the miniature receiver.

The voice coil may typically be in the form of a cylinder or a cuboid with the top side and bottom side of the cylinder or cuboid being open. The top side of the voice coil may be the part of the voice coil nearest to the moveable portion of the diaphragm. The bottom side of the voice coil may be the part opposite the top side and furthest away from the moveable portion of the diaphragm. The rim or edge of the top side (and/or bottom side) of the voice coil may in principle take any shape, including an elliptical shape or a circular shape. The rim or edge of the top-side (and/or bottom side) of a cuboid voice coil may take a substantially square shape or a substantially rectangular shape. If desired, the rims or edges of the substantially square or rectangular shape may be rounded or curved. In the present specification, the cuboid shaped voice coil is referred to as a substantially square voice coil (also referred to in this specification as quadratic voice coil) or rectangular voice coil. The cylindrically shaped voice coil may be referred to as a circular shaped voice coil. Finally, elliptically (oval-shaped) shaped voice coils also exist.

The length of the hinged diaphragm in the oblong direction may be at least twice the diameter or the width of the voice coil secured to the moveable portion of the diaphragm. Thus, the length of the hinged diaphragm in the oblong direction may be three times, four times, five times or even ten times the diameter or the width of the voice coil. The width of the voice coil may correspond to the side length of a square voice coil or the shortest side length of a rectangular voice coil. The diameter of the voice coil may correspond to the shortest diameter of an elliptically (oval shaped) voice coil or the diameter of a circular shaped voice coil.

An air venting opening may be arranged in the oblong housing of the miniature receiver. The air venting opening may be displaced or shifted relative to the magnetic motor. The air venting opening may be oppositely arranged relative to the sound outlet port, or it may be arranged as side opening in the oblong housing. In any case, the air venting opening may be adapted to vent the rear volume of the miniature receiver.

The venting opening may comprise an acoustical filter element forming an acoustical filter having an acoustical resistance, such as an acoustical low-pass filter having an acoustical resistance in the range of 1-5 GPa·s/m³.

The cut-off frequency of such an acoustical low-pass filter may be in range of 100-1000 Hz, such as 200-800 Hz, and the acoustical low-pass filter may be implemented as a mesh comprising one or more small holes (drilled or laser-cut), wire mesh, grid, fabric, non-woven fabric or another arrangement with similar acoustical properties. The purpose of the acoustical filter is to allow the rear volume of the miniature receiver to be vented for signal frequencies below the filter cut-off, and to inhibit venting for frequencies above the cut-off. The advantage of such a filter is that the low frequency output is increased, while the resonance frequencies are not affected by the additional volume. The main property of the acoustical filter is the acoustical resistance. The acoustical resistance of the acoustical filter that is required to achieve a certain cut-off frequency is dependent of the acoustical compliance of the rear volume. For example, with a rear volume of 25 mm³, the acoustical resistance should be between 1.1 and 4.5 GPa·s/m³ in order to have the cut-off between 200 and 800 Hz. Alternatively, in order to have a cut-off frequency of 500 Hz with a rear volume between 15 and 30 mm³, the acoustical resistance of the acoustical filter should be between 1.3 and 3 GPa·s/m³.

The oblong housing of the miniature receiver may be defined by first and second oblong housing parts in combination. The sound outlet port may be arranged in the first oblong housing part, and the air venting opening may be arranged in the second oblong housing part. The frame structure around the hinged diaphragm may form at least part of a sealing between the first and second oblong housing parts, and electrical terminals may be provided on an exterior surface of the oblong housing.

The magnetic motor may be distinct and separate motor. The magnetic motor may thus comprise a stacked arrangement of a permanent magnet and an inner yoke, wherein the permanent magnet and the inner yoke are at least partly arranged within an outer yoke so that an air gap is provided between the inner yoke and the outer yoke. The air gap is adapted to receive at least part of the voice coil, i.e. the voice coil is at least partly arranged within the air gap.

The outer yoke may comprise one or more ventilation openings adapted to ventilate an air volume inside the magnetic motor. Proper ventilation of the magnetic motor is advantageous as it may lead to an increased performance of the miniature receiver.

The magnetic motor may alternatively form part of the housing of the miniature receiver in order to increase the power of the motor. In this implementation the magnetic motor may comprise a stacked arrangement of a permanent magnet and an inner yoke, wherein the permanent magnet and the inner yoke are at least partly arranged within an outer yoke formed by a portion of the oblong housing. Thus, in this implementation a housing part of the miniature receiver may form at least part of an outer yoke of the magnetic motor.

In case a housing part of the miniature receiver forms at least part of an outer yoke of the magnetic motor, the voice coil preferably has an elongated shape, such as a rectangular shape or oval shaped. The longest extension/elongation, such as the longest side length of a rectangular voice coil or the largest diameter of an oval shaped voice coil, may be arranged substantially parallel to the oblong direction of the hinged diaphragm. In this embodiment, the length of the hinged diaphragm in the oblong direction is at least 1.1 times, preferably at least 1.2 times, 1.3 times or 1.4 times, such as 1.5 times the longest extension/elongation of the voice coil, such as the largest diameter or the longest side length, of the voice coil secured to the moveable portion of the diaphragm. The length of the hinged diaphragm in the oblong direction may be up to 4 times, such as up to 3 times, 2.5 times, or 2 times the longest extension/elongation, such as the largest diameter or the longest side length of the voice coil.

As already mentioned, the oblong housing of the miniature receiver may have an outer width within the range of 3-4 mm, an outer height within the range of 1.5-2.5 mm, and an outer length within the range of 6-9 mm.

In a second aspect the present invention relates to an audio assembly for a hearing device comprising a nozzle comprising a sound channel and a sound outlet acoustically connected to the sound channel, wherein a miniature receiver according to the first aspect is at least partly positioned in the sound channel.

In a third aspect the present invention relates to a hearing device comprising the miniature receiver according to the first aspect, or an audio assembly according to the second aspect.

In general, the various aspects of the present invention may be combined and coupled in any way possible within the scope of the invention. These and other aspects, features and/or advantages of the present invention will be apparent from and elucidated with reference to the embodiments described hereinafter.

### BRIEF DESCRIPTION OF THE DRAWINGS

The present invention will now be described with reference to the accompanying drawings wherein

FIG. 1 illustrates a cross-sectional view of an oblong miniature receiver according to the present invention,

FIG. 2 illustrates a top view of a hinged diaphragm of an oblong miniature receiver according to the present invention,

FIG. 3 illustrates top views of other hinged diaphragms, where FIG. 3a shows a film-based hinge, and FIG. 3b shows two distinct and separate glue hinges,

FIG. 4 illustrates cross-sectional views of different ways of venting of the volume enclosed by the voice coil. In FIG. 4a the venting is provided via the embossment of the diaphragm, and in FIG. 4b the venting is provided via venting holes in the outer yoke,

FIG. 5 illustrates different embodiments for stiffening of the diaphragm. In FIG. 5a the stiffening is provided by means of an embossment, in FIG. 5b the stiffening is provided by means of a stacked layer, and in FIG. 5c the stiffening is provided by means of a stacked pre-formed layer,

FIG. 6 illustrates the effect of the positioning of the voice coil (on the hinged diaphragm) relative to the hinge,

FIG. 7 illustrates the positioning of the voice coil relative to the hinge, and different positions of the venting opening and the acoustical filter,

FIG. 8 illustrates different implementations of the magnet circuit motor. FIG. 8a shows a circular motor design, FIG. 8b shows a square motor design, FIG. 8c shows another circular motor design with larger coil and magnet, and FIG. 8d shows a rectangular motor design,

FIGS. 9a-c illustrate different implementations of the magnet circuit motor, where part of the receiver housing is used as an outer yoke,

FIG. 10 illustrates a hearing device comprising an oblong miniature receiver according to the invention, and

FIG. 11 illustrates a cross-sectional view of another oblong miniature receiver according to the present invention, wherein a housing part of the miniature receiver forms at least part of an outer yoke of a magnetic motor having a rectangular voice coil.

### DETAILED DESCRIPTION OF THE INVENTION

In general, the present invention relates to an oblong miniature receiver for hearing devices. The oblong miniature receiver of the present invention comprises a hinged diaphragm comprising a hinged portion and a moveable portion, wherein at least the moveable portion of the hinged diaphragm is adapted to vibrate, and thus generate sound waves, in response to a drive signal applied to a voice coil secured to the moveable portion of the diaphragm. The oblong miniature receiver of the present invention is advantageous in that its form factor allows it to be arranged in for example a sound channel of a nozzle of a hearing device. With this arrangement of the oblong miniature receiver an acoustical passage having an acoustical mass may be formed between the housing of the oblong miniature receiver and the nozzle. This arrangement is advantageous in that it facilitates that a fundamental acoustical resonance peak at around 6-8 kHz may be provided. A fundamental acoustical resonance peak in this range is advantageous in that it facilitates an increased bandwidth of the hearing device incorporating the oblong miniature receiver.

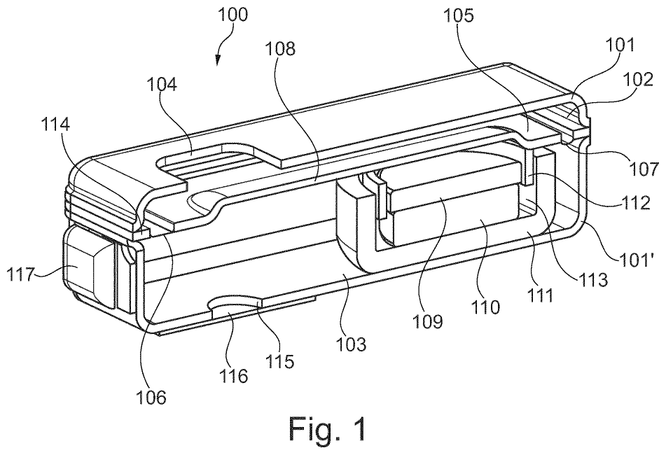

Referring now to FIG. 1, a cross-sectional side-view of an oblong miniature receiver 100 comprising a hinged diaphragm is depicted. The oblong miniature receiver 100 comprises a housing 101, 101′ with a sound outlet port 104 and a venting opening 115 arranged therein. The venting opening 115 has an acoustical filter 116 having an acoustical resistance, such as a low-pass filer having an acoustical resistance in the range of 1-5 GPa·s/m³, arranged therein. Within the housing 101, 101′ of the oblong miniature receiver 100 a front volume 102 and a rear volume 103 are provided. These volumes 102, 103 are separated by a hinged diaphragm 105. The hinged diaphragm 105 comprises a hinged portion closest to one or more hinges and a moveable portion, wherein at least the moveable portion of the hinged diaphragm 105 is adapted to vibrate, and thus generate sound waves, in response to a drive signal applied to a voice coil 112 secured to the moveable portion of the hinged diaphragm 105. As seen in FIG. 1 at least part of the hinged diaphragm 105 comprises an embossed part 108 for increasing the stiffness of the diaphragm and/or for providing an air venting path so that the air volume 113 inside the magnetic motor can be vented. The magnetic motor comprises a permanent magnet 110 sandwiched between a centre yoke 109 and an outer yoke 111. The centre yoke 109 and the outer yoke 111 form an air gap within which at least part of the voice coil 112 is positioned.

As seen in FIG. 1, the hinged diaphragm 105 is hinged via one or more hinges 106 to a frame structure 114. The hinged diaphragm 105 and the frame structure 114 preferably form an integrated structure of the same material, such as metal including aluminium. The hinged diaphragm 105 and the frame structure 114 are separated by one or more openings which are at least partly filled with a flexible sealing member 107, such as a corrugated polymer film or a viscoelastic gel. With the flexible sealing member 107 applied in the one or more openings between the hinged diaphragm 105 and the frame structure 114, the front and rear volumes 102, 103 are acoustically sealed from each other.

As also seen in FIG. 1, the length of the hinged diaphragm 105 is significantly longer than both the width/diameter of the magnetic motor 109, 110, 111 and the diameter of the voice coil 112. In fact, the length of the hinged diaphragm 105 is at least twice the width/diameter of the magnetic motor 109, 110, 111 and the diameter of the voice coil 112. An electrical terminal 117 is provided on the exterior of the housing 101, 101′. The electrical terminal 117 is electrically connected to the voice coil 112 so that a drive signal can be provided thereto.

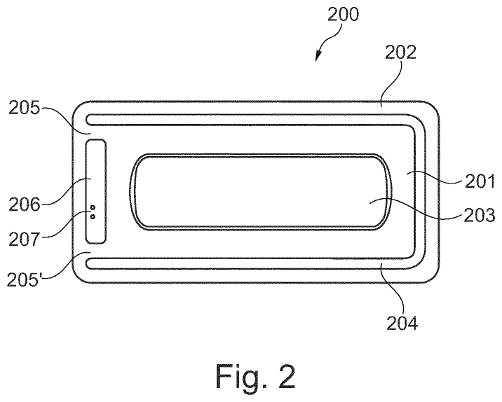

Turning now to FIG. 2, a top view of an integrated assembly 200 comprising the hinged diaphragm 201 and the frame structure 202 are depicted. As already mentioned, the hinged diaphragm 201 and the frame structure 202 preferably form an integrated structure of the same material, such as metal including aluminium. The hinged diaphragm 201 is hinged to the frame structure 202 via hinges 205, 205′ that are integrated hinges. The openings 204, 206 between the hinged diaphragm 201 and the frame structure 202 are sealed with a corrugated polymer film having one or more venting opening 207 arranged between the hinges 205, 205′. These one or more venting openings are provided in order equalize the barometric pressure between the front and the rear volume, cf. FIG. 1. At least part of the hinged diaphragm 201 comprises an embossed part 203 for increasing the stiffness of the diaphragm and/or for providing an air venting path as it will be discussed in further details below.

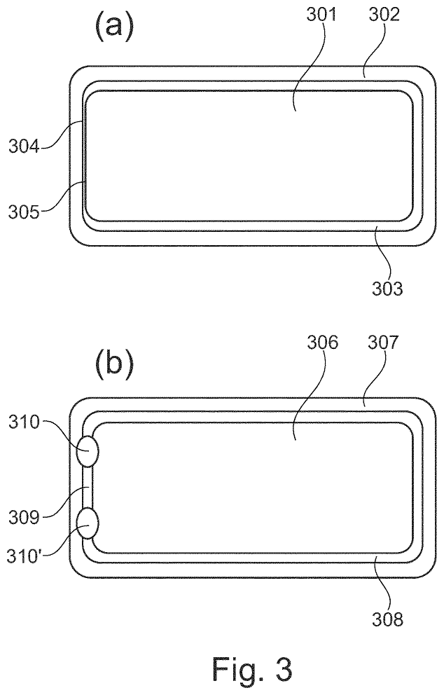

In an alternative arrangement, the hinged diaphragm 301, 306 is hinged to the frame structure 302, 307 via discrete and separate glue hinges 304, 310, 310′, cf. FIGS. 3a-b. With reference to FIG. 3a a thin film 305 in the narrow gap between the hinged diaphragm 301 and the frame structure 302 act as a hinge 304. The opening 303 between the hinged diaphragm 301 and the frame structure 302 is sealed with a corrugated polymer film. In FIG. 3b discrete and separate hinges 310, 310′ are secured to the hinged diaphragm 306 and the frame structure 307. The opening 308 between the hinged diaphragm 306 and the frame structure 307 is sealed with a corrugated polymer film, and the opening 309 between the hinges 310, 310′ is sealed with a film that may comprise venting/barometric openings (not shown).

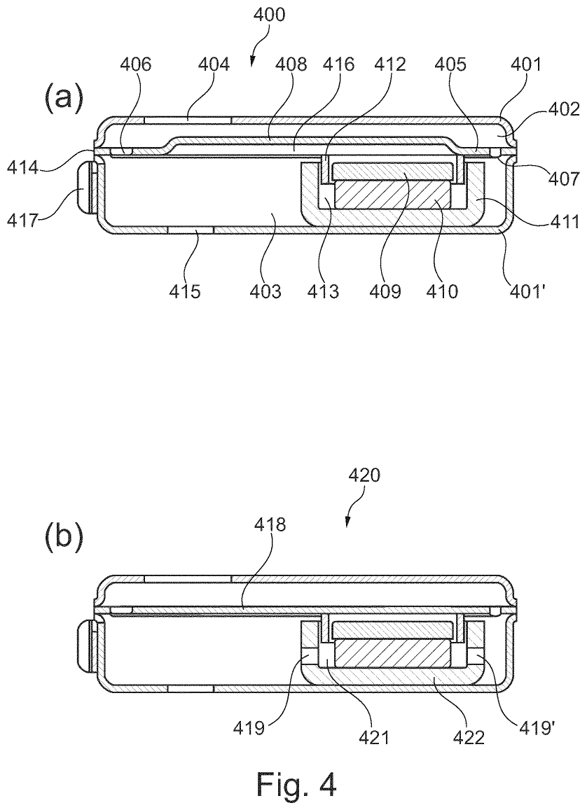

FIGS. 4a-b show embodiments of the present invention where the oblong miniature receiver 400, cf. FIG. 4a, comprises hinged diaphragm 405 with an embossed part 408, and wherein FIG. 4b shows an oblong miniature receiver 420 with a flat hinged diaphragm 418.

Returning to FIG. 4a, the oblong miniature receiver 400 comprises a housing 401, 401′ with a sound outlet port 404 and a venting opening 415 arranged therein. The venting opening 415 may have an acoustical filter (not shown), such as a low-pass filer, arranged therein. Within the housing 401, 401′ a front volume 402 and a rear volume 403 are provided. These volumes 402, 403 are separated by the hinged diaphragm 405. The hinged diaphragm 405 comprises a hinged portion and a moveable portion, wherein at least the moveable portion of the hinged diaphragm 405 is adapted to vibrate, and thus generate sound waves, in response to a drive signal applied to a voice coil 412 secured to the moveable portion of the hinged diaphragm 405. As seen in FIG. 4a at least part of the hinged diaphragm 405 comprises an embossed part 408 for increasing the stiffness of the diaphragm and/or for providing an air venting path so that the air volume 413 inside the magnetic motor can be vented. The magnetic motor comprises a permanent magnet 410 sandwiched between a centre yoke 409 and an outer yoke 411. The centre yoke 409 and the outer yoke 411 form an air gap within which at least part of the voice coil 412 is positioned. The hinged diaphragm 405 is hinged via one or more hinges 406 to a frame structure 414. The hinged diaphragm 405 and the frame structure 413 preferably form an integrated structure of the same material, such as metal including aluminium. The hinged diaphragm 405 and the frame structure 413 are separated by one or more openings which are at least partly filled with a flexible sealing member 407, such as a corrugated polymer film or a viscoelastic gel. With the flexible sealing member 407 applied in the one or more openings between the hinged diaphragm 405 and the frame structure 413, the front and rear volumes 402, 403 are acoustically sealed from each other.

Referring now to FIG. 4b the flat hinged diaphragm 418 does not provide an air venting path for venting the air volume 421. To compensated for this, one or more venting openings 419, 419′ are in the outer yoke 422. Otherwise, the oblong miniature receiver 400 (FIG. 4a) is identical to the oblong miniature receiver 420 (FIG. 4b).

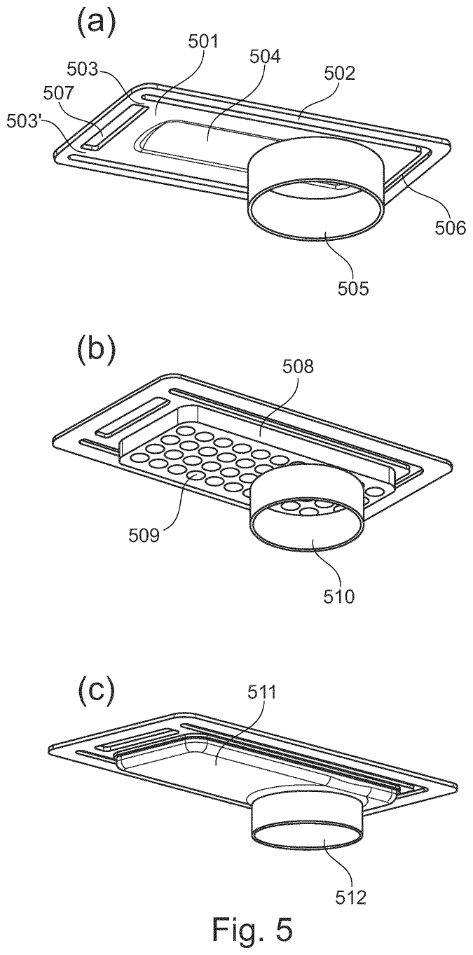

FIG. 5a-c show various implementations for increasing the stiffness of the hinged diaphragm. In FIG. 5a the hinged diaphragm 501 is hinged to the frame structure 502 via integrated hinges 503, 503′. The hinged diaphragm 501, the frame structure 502 and the integrated hinges 503, 503′ are preferably made of the same material, such as metal including aluminium. The openings 506, 507 are sealed with film, such as a corrugated polymer film optionally having on one or more venting opening arranged therein. The hinged diaphragm 501 comprises an embossed part 504 for increasing the stiffness of the diaphragm and/or for providing an air venting path as it will be discussed in further details below. The voice coil 505 is secured to a none-embossed part of the hinged diaphragm 501 to that a venting path is provided between the embossed part 504 and the voice coil 505. In FIG. 5b a stacked layer 508 with holes 509 arranged therein is secured to the hinged diaphragm. The purpose of the holes 509 is to reduce the mass of the stacked layer 508. The voice coil 510 is secured to the stacked layer 508. In FIG. 5c a formed stacked layer 511 is secured to the hinged diaphragm, and the voice coil 512 is secured to the formed stacked layer 511. The formed stacked layer may comprise multiple layers of different materials, some of which may have holes. Moreover, the formed stacked layer may be the same material as the hinged diaphragm and may be attached to a flat hinged diaphragm. There may be a layer of air between the flat diaphragm and the formed stacked layer, or a layer of another material, e.g. a porous material. Alternatively, the flat hinged diaphragm may be perforated at the area where it is covered with formed stacked layer.

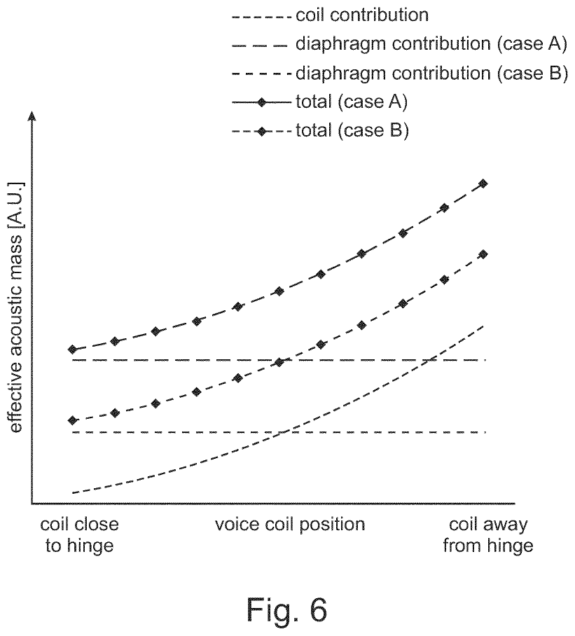

FIG. 6 illustrates the effect of the positioning of the voice coil close to or distant from the hinge of the hinged diaphragm. In general, the position of the voice coil relative to hinge affects the output of the receiver in multiple ways. Firstly, for the same air displacement of the hinged diaphragm, the vertical displacement of a voice coil close to the hinge is smaller than for a voice coil placed distant from the hinge. As a consequence, the same voice coil current will generate a higher output sound pressure level when the voice coil is positioned distant from the hinge than when the voice coil is positioned close to the hinge. Secondly, the contribution of the moving mass of the voice coil to the effective acoustical mass is smaller for a voice coil placed close to the hinge than for a voice coil positioned distant from the hinge. As a consequence, the bandwidth of a miniature receiver with a voice coil positioned close to the hinge can be larger than for a voice coil positioned distant from the hinge. In FIG. 6 this is illustrated for two cases namely case A in which the hinged diaphragm is relatively heavy, and the voice coil contribution to the total effective acoustic mass is small relative to the diaphragm contribution, and case B in which the diaphragm is relatively light, and the voice coil contribution to the total effective acoustic mass is large relative to the diaphragm contribution. In the latter case it is advantageous to place the voice coil close to the hinge to maximize the bandwidth.

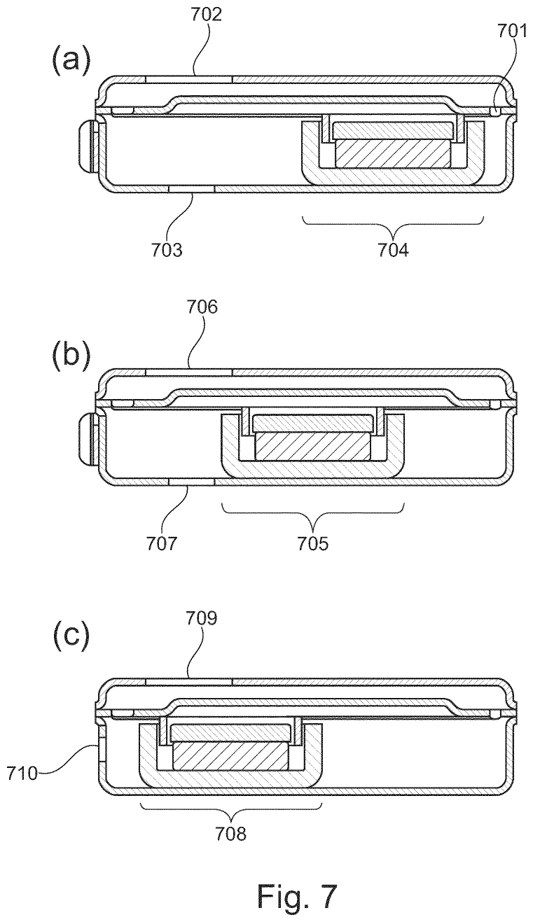

Turning now to FIGS. 7a-c, various positions of the voice coil/magnetic motor 704, 705, 706 relative to the hinge 701 are depicted. In FIG. 7a the voice coil/magnetic motor 704 is positioned close to the hinge 701. As seen in FIG. 7a, the oblong miniature receiver comprises oppositely arranged sound output port 702 and venting opening 703. In FIG. 7b the voice coil/magnetic motor 705 is positioned in the centre of the hinged diaphragm. Again, the oblong miniature receiver comprises oppositely arranged sound output port 706 and venting opening 707. In FIG. 7c the voice coil/magnetic motor 708 is positioned opposite to, i.e. furthest from, the hinge of the hinged diaphragm. The oblong miniature receiver comprises a sound output port 709 and venting opening 710 in a side portion of the housing. An acoustical filter, such as a low-pass filter, may be positioned in the venting openings 703, 707, 710.

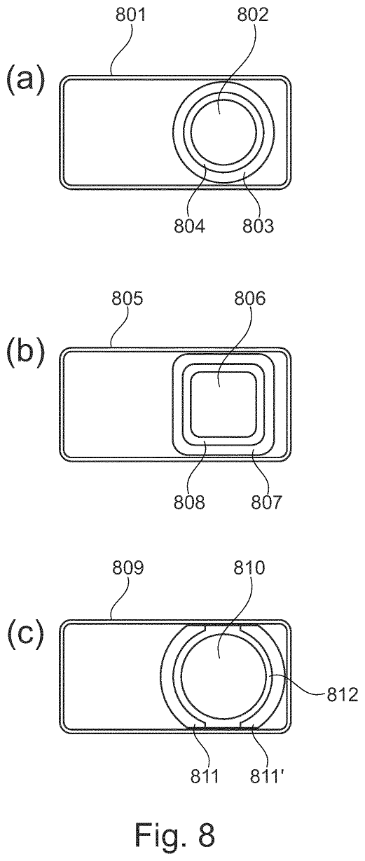

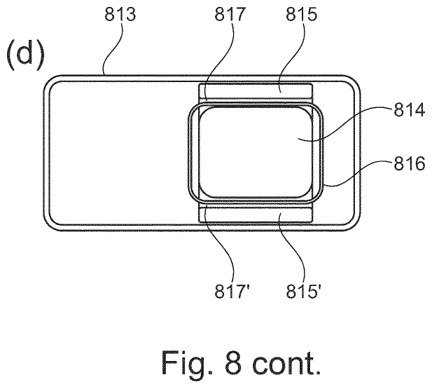

FIGS. 8a-d show various implementations (from a top view perspective) of the magnetic motor within the respective housings 801, 805, 809, 813. In FIG. 8a a cylindrical magnetic motor comprises a disc shaped inner yoke 802 arranged on a permanent magnet (not visible). Moreover, the magnetic motor comprises an outer yoke 803, and wherein an air gap 804 is formed between the inner yoke 802 and the outer yoke 803. The air gap 804 is adapted to receive at least a portion of a cylindrical voice coil (not shown). The magnetic motor of FIG. 8a is similar to the motor depicted in FIG. 1. In FIG. 8b a (substantially) rectangular/square magnetic motor comprises an inner yoke 806 arranged on a permanent magnet (not visible). Moreover, the magnetic motor comprises an outer yoke 807, and wherein an air gap 808 is formed between the inner yoke 806 and the outer yoke 807. The air gap 804 is adapted to receive at least a portion of a (substantially) rectangular/square voice coil (not shown). FIG. 8c also shows a cylindrical magnetic motor comprising a disc shaped inner yoke 810 arranged on a permanent magnet (not visible). Moreover, the magnetic motor comprises a segmented outer yoke 811, 811′, and wherein an air gap 812 is formed between the inner yoke 810 and the outer yoke segments 811, 811′. The air gap 812 is adapted to receive at least a portion of a cylindrical voice coil (not shown). In FIG. 8d a rectangular/square magnetic motor comprises an inner yoke 814 arranged on a permanent magnet (not visible). Moreover, the magnetic motor comprises a segmented outer yoke 815, 815′, and wherein two air gaps 817, 817′ are formed between the inner yoke 814 and the segmented outer yoke 815, 815′. The air gaps 817, 817′ are adapted to receive at least portions of a rectangular/square voice coil 816.

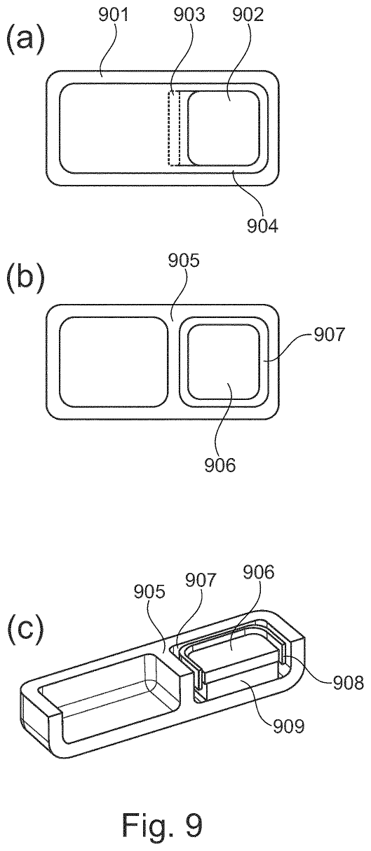

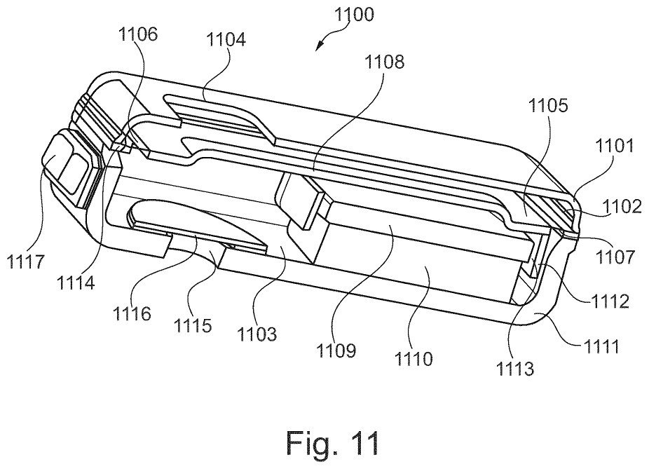

FIG. 9a-c shows various implementations (from a top view perspective) where the respective housings 901, 905 of the oblong miniature receiver form part of the magnetic motor. Referring now to FIG. 9a the housing 901 forms an outer yoke relative to the inner yoke 902. An optional further outer yoke 903 may be provided. FIG. 11 depicts a miniature receiver where the outer yoke 903 is omitted. In the embodiment where outer yoke 903 is omitted, the inner yoke 902 preferably has an elongated shape such as a (substantially) rectangular shape. An air gap 904 is formed between the inner yoke 902 and the outer yoke 901 (and 903 if present). The air gap 904 is adapted to receive at least part of a voice coil (not shown). The inner yoke 902 is arranged on a permanent magnet (not visible). In FIG. 9b the housing 905 forms an entire outer yoke relative to the inner yoke 906 which is arranged on a permanent magnet (not visible). An air gap 907 is formed between the inner yoke 906 and the outer yoke 905. The air gap 907 is adapted to receive at least part of a voice coil (not shown). FIG. 9c shows the same implementation as FIG. 9b, but both the permanent magnet 909 and the voice coil 908 are visible in FIG. 9c.

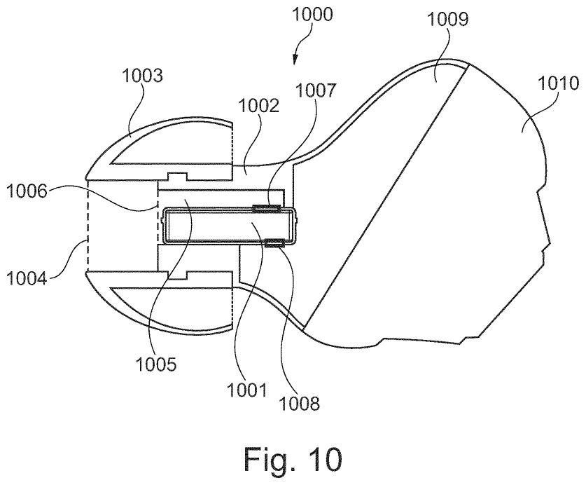

In FIG. 10 the oblong miniature receiver 1001 forms part of an acoustical assembly 1000 comprising a nozzle 1002 and a flexible dome 1003. As seen in FIG. 10, the oblong miniature receiver 1001 is arranged in a sound channel of the nozzle 1002 to that an acoustical passage 1005 is formed alone the length of the oblong miniature receiver 1001. The acoustical passage 1005 is acoustically coupled to a sound outlet port 1007 of the oblong miniature receiver 1001 and a nozzle outlet 1006. The flexible dome 1003 is secured to the nozzle 1002. The venting opening 1008 is adapted to vent the rear volume of the oblong miniature receiver 1001, and as seen in FIG. 10 the venting opening 1008 is acoustically connected to an external rear volume 1009 within the housing 1010 of the hearing device.

Referring now to FIG. 11, a cross-sectional side-view of an oblong miniature receiver 1100 comprising a hinged diaphragm is depicted. The oblong miniature receiver 1100 comprises a housing 1101, 1111 with a sound outlet port 1104 and a venting opening 1115 arranged therein. A part of the housing 1111 is, as depicted in FIG. 11, adapted to function as at least part of an outer yoke of a magnetic motor. As seen in FIG. 11 the magnetic motor comprises a permanent magnet 1110 sandwiched between a centre yoke 1109 and the housing part/outer yoke 1111. The centre yoke 1109 and the housing part/outer yoke 1111 form an air gap 1113 within which at least part of a voice coil 1112 is positioned. The housing part 1111 which is adapted to function as at least part of an outer yoke is typically made of a nickel/iron alloy such as mu-metal.

The venting opening 1115 comprises an acoustical filter 1116, such as a low-pass filter, having an acoustical resistance in the range of 1-5 GPa·s/m³. The acoustical filter 1116 may be implemented in various ways, such as an acoustical mesh.

Within the housing 1101, 1111 of the oblong miniature receiver 1100, a front volume 1102 and a rear volume 1103 are provided. These volumes 1102, 1103 are separated by a hinged diaphragm 1105. The hinged diaphragm 1105 comprises a hinged portion closest to one or more hinges 1106 and a moveable portion, wherein at least the moveable portion of the hinged diaphragm 1105 is adapted to vibrate, and thus generate sound waves, in response to a drive signal applied to a voice coil 1112. The voice coil 1112 is secured to the moveable portion of the hinged diaphragm 1105. At least part of the hinged diaphragm 1105 comprises an embossed part 1108 for increasing the stiffness of the diaphragm.

As seen in FIG. 11 the hinged diaphragm 1105 is hinged via one or more hinges 1106 to a frame structure 1114. The hinged diaphragm 1105 and the frame structure 1114 preferably form an integrated structure of the same material, such as a metal including aluminium. The hinged diaphragm 1105 and the frame structure 1114 are separated by one or more openings which are at least partly filled with a flexible sealing member 1107, such as a (corrugated) polymer film or a viscoelastic substance, such as a viscoelastic gel. With the flexible sealing member 1107 applied in the one or more openings between the hinged diaphragm 1105 and the frame structure 1114, the front and rear volumes 1102, 1103 are acoustically sealed from each other. An electrical terminal 1117 is provided on the exterior of the oblong miniature receiver 1100, more particularly on the exterior of the housing 1101, 1111. The electrical terminal 1117 is electrically connected to the voice coil 1112 so that a drive signal can be provided thereto via the electrical terminal 1117.

As also seen in FIG. 11 the length of the hinged diaphragm 1105 is significantly longer than both the width of the inner yoke of the magnetic motor 1109 and the width of the voice coil 1112. In fact, the length of the hinged diaphragm 1105 is at least twice the width of the inner yoke of the magnetic motor 1109 and the width of the voice coil 1112. It is also seen from FIG. 11 that the inner yoke 1109 and the permanent magnet 1110 of the magnetic motor and the voice coil 1112 have a rectangular shape-the voice coil 1112 though having rounded/curved corners. The length of the hinged diaphragm 1105 is about 1.5 times the length of the voice coil 1112.

In terms of performance the oblong miniature receiver according to the present invention has a low-frequency output at 100 Hz (1 Vrms) at around 120 dB SPL, and a maximum output at the first resonance peak (around 2 kHz) at 122 dB SPL. The mechanical resonance frequency of the hinged diaphragm is around 15 kHz.

Although the present invention has been discussed in the foregoing with reference to exemplary embodiments of the invention, the invention is not restricted to these particular embodiments which can be varied in many ways without departing from the invention. The discussed exemplary embodiments shall therefore not be used to construe the appended claims strictly in accordance therewith. On the contrary, the embodiments are merely intended to explain the wording of the appended claims, without intent to limit the claims to these exemplary embodiments. The scope of protection of the invention shall therefore be construed in accordance with the appended claims only, wherein a possible ambiguity in the wording of the claims shall be resolved using these exemplary embodiments.

1. A miniature receiver for a hearing device, said miniature receiver comprising
1) an oblong housing,
2) a sound output port arranged in the oblong housing,
3) a hinged diaphragm arranged within the oblong housing and separating a front volume and a rear volume within the oblong housing, wherein the hinged diaphragm comprises a hinged portion and a moveable portion, and wherein at least the moveable portion of the hinged diaphragm is adapted to vibrate in response to a drive signal applied to a voice coil secured to the moveable portion of the diaphragm, and
4) a magnetic motor arranged within the oblong housing, wherein the magnetic motor is adapted to generate a static magnetic field in an air gap within which at least part of the voice coil is positioned.

2. A miniature receiver according to claim 1, wherein the hinged diaphragm is hinged to a frame structure, and wherein one or more openings exist between the hinged diaphragm and the frame structure.

3. A miniature receiver according to claim 2, wherein the hinged portion of the hinged diaphragm is hinged to a frame structure via one or more discrete and separate hinges and/or via one or more integrated hinges.

4. A miniature receiver according to claim 2, wherein the hinged diaphragm and the frame structure form an integrated structure of the same material, such as metal including aluminium.

5. A miniature receiver according to claim 2, wherein the one or more openings between the hinged diaphragm and the frame structure are at least partly be sealed or filled with a flexible sealing member, such as a corrugated polymer film or a viscoelastic substance.

6. A miniature receiver according to claim 1, wherein at least part of the hinged diaphragm comprises an embossed part for increasing the stiffness of the diaphragm.

7. A miniature receiver according to claim 1, wherein the hinged diaphragm has an oblong shape, wherein the length of the hinged diaphragm in the oblong direction is at least twice the width of the diaphragm.

8. A miniature receiver according to claim 7, wherein the length of the hinged diaphragm in the oblong direction is at least twice the diameter or the width of the voice coil secured to the moveable portion of the diaphragm.

9. A miniature receiver according to claim 1, wherein an air venting opening is arranged in the oblong housing of the miniature receiver, and wherein the air venting opening is displaced relative to the magnetic motor.

10. A miniature receiver according to claim 9, wherein the air venting opening is adapted to vent the rear volume of the miniature receiver, and wherein the air venting opening comprises an acoustical filter element forming an acoustical filter, such as an acoustical low-pass filter.

11. A miniature receiver according to claim 9, wherein the oblong housing is defined by first and second oblong housing parts in combination, wherein the sound outlet port is arranged in the first oblong housing part, and wherein the air venting opening is arranged in the second oblong housing part.

12. A miniature receiver according to claim 1, wherein the magnetic motor comprises a stacked arrangement of a permanent magnet and an inner yoke, wherein the permanent magnet and the inner yoke are at least partly arranged within an outer yoke so that an air gap is provided between the inner yoke and the outer yoke within which air gap the voice coil is at least partly arranged.

13. A miniature receiver according to claim 1, wherein the magnetic motor comprises a stacked arrangement of a permanent magnet and an inner yoke, wherein the permanent magnet and the inner yoke are at least partly arranged within an outer yoke formed by a portion of the oblong housing.

14. An audio assembly for a hearing device, the audio assembly comprising a nozzle comprising a sound channel and a sound outlet acoustically connected to the sound channel, wherein a miniature receiver according to claim 1 is at least partly positioned in the nozzle, such as at least partly positioned in the sound channel of the nozzle.

15. A hearing device comprising the miniature receiver according to claim 1.

16. A hearing device comprising the audio assembly according to claim 14.
